(19) United States
(12) Patent Application Publication
(10) Pub. No.: US 2008/0089547 A1
(43) Pub. Date: Apr. 17, 2008

(54) Digital audio speaker system for digital audio players with motorized drawer mechanism

(75) Inventors: Darin C. Young, Indianapolis, IN (US); Lawrence C. Coan, Indianapolis, IN (US); David O. Swett, Waltham, MA (US); James Pelletier, North Grafton, MA (US); John P. Devlin, Tewksbury, MA (US)

Correspondence Address: KRIEG DEVAULT LLP, ONE INDIANA SQUARE, SUITE 2800, INDIANAPOLIS, IN, 46204-2079, US

(73) Assignee: Klipsch, LLC

(21) Appl. No.: 11/580,446

(22) Filed: Oct. 13, 2006

(51) Int. Cl. H04R 1/02

(52) U.S. Cl. 381/386; 381/395

(57) ABSTRACT

A digital audio speaker system for a digital audio player that includes a housing and a control unit positioned in the housing. An amplifier is positioned in the housing and connected with the control unit and a speaker system. A frame assembly is positioned in the housing that includes a motorized drive assembly. A drawer assembly is movably connected with the motorized drive assembly. The motorized drive assembly is operable to move the drawer assembly between an open position and a closed position.

### BACKGROUND

The present invention relates generally to audio systems and more particularly, to a digital audio speaker system for a portable digital audio player that includes a motorized docking drawer that is operable to move between an open or exposed position and a closed or concealed position.

A digital audio player (“DAP”) is a device that stores, organizes and plays digital music files. DAPs are commonly referred to in the industry as MP3 players (because of that file formats ubiquity), but most DAPs are capable of playing many additional types of file formats such as WAV files, AIFF files, Vorbis files, and lossy Windows Media Audio files to name a few. DAPs may store digital music files on internal or external media, such as memory cards. These devices are portable, typically employing internal rechargeable or replaceable batteries and headphones. Some DAPs include FM radio tuners or are capable of being connected with external FM radio tuner devices so that the digital music files stored therein may be heard over, for example, a car stereo system.

As the popularity of DAPs continues to grow, several types of digital music speaker systems have been developed that are capable of receiving a DAP and playing the music stored therein over a speaker system. Digital audio speaker systems are often utilized in rooms of a home, but other versions are portable. Some of these systems have been designed so that a respective DAP may be “docked” in a docking area. One such digital music system marketed by the assignee of the present invention, Klipsch®, is the iGroove™.

The docking area of existing digital audio speaker systems for DAPs is exposed to the environment when not in use. Therefore, the exposed docking area is susceptible to physical damage such as accidental bumping or purposeful pulling or pushing. The docking area may also become contaminated with debris over time thereby affecting the functionality of the system. In addition, in some digital audio speaker systems, the docking area may be unsightly when not in use and detract from the overall aesthetic appearance of the system. As such, a need exists for a digital audio speaker system for DAPs that conceals the docking area when not in use to reduce the possibility of physical damage or contamination from debris and to improve the overall appearance of the system.

### SUMMARY

One embodiment according to the present invention discloses a unique digital audio speaker system for a DAP that includes a motorized drawer assembly. Other embodiments include unique apparatuses, systems, devices, hardware, methods, and combinations of these for docking a portable DAP with a digital audio speaker system that includes a docking area that is operable to be placed in a concealed position when not in use. Further embodiments, forms, objects, features, advantages, aspects, and benefits of the present invention shall become apparent from the following description and drawings.

### BRIEF DESCRIPTION OF THE DRAWINGS

FIG. 1 illustrates a preferred digital audio speaker system for a digital audio player having a drawer in a closed position.

FIG. 2 illustrates the digital audio speaker system set forth in FIG. 1 wherein the drawer is in the open position.

FIG. 3 is a block diagram illustrating various components of the digital audio speaker system.

FIG. 4 illustrates the components of a drawer assembly of the digital audio speaker system.

FIG. 5 illustrates the drawer assembly illustrated in FIG. 4 assembled.

FIG. 6 illustrates the components of a frame assembly of the digital audio speaker system.

FIG. 7 illustrates the frame assembly illustrated in FIG. 6 assembled.

FIG. 8 illustrates the frame assembly connected with the drawer assembly wherein the drawer assembly is in the closed position.

FIG. 9 illustrates the frame assembly connected with the drawer assembly wherein the drawer assembly is in the open position.

### DETAILED DESCRIPTION OF ILLUSTRATIVE EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention is illustrated therein being contemplated as would normally occur to one skilled in the art to which the invention relates.

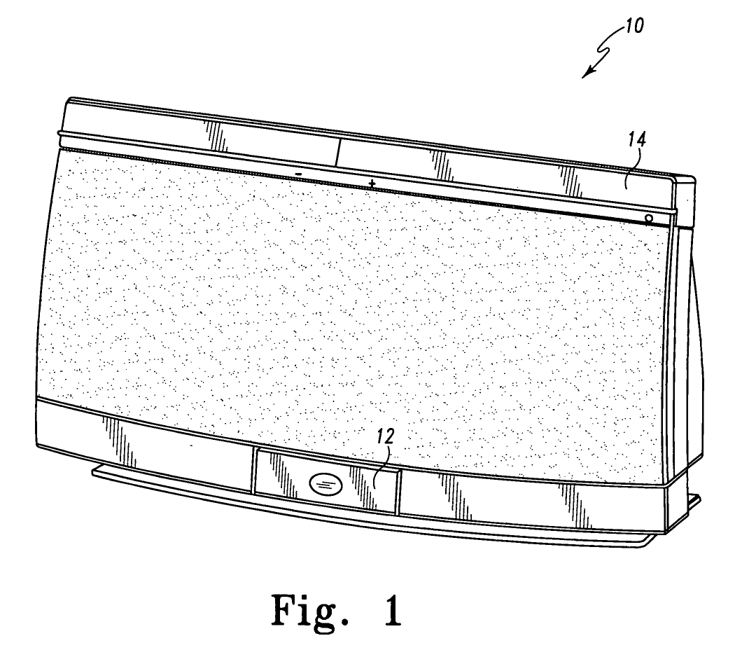

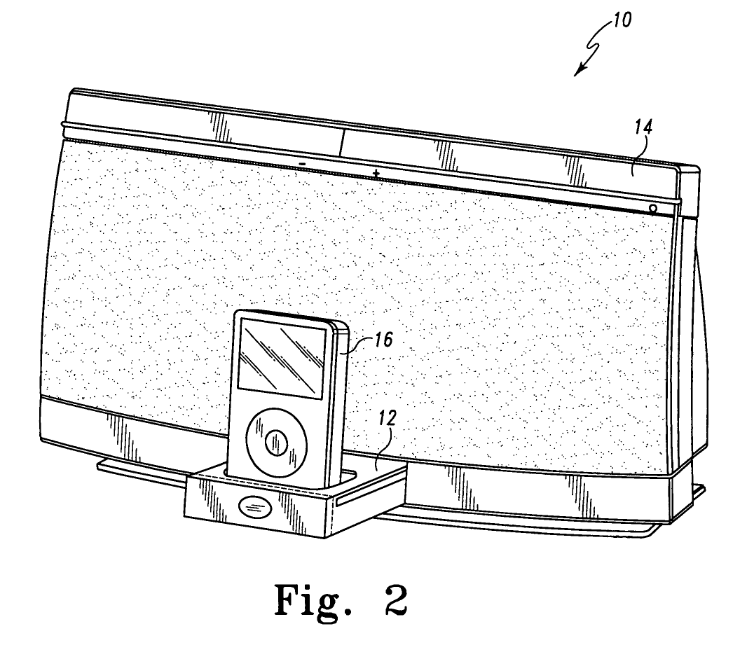

With reference to FIGS. 1 and 2, there is illustrated, a digital audio speaker system 10 that includes a drawer assembly 12 located in a housing 14. As illustrated in the figures, the drawer assembly 12 of the audio speaker system 10 is operable to move or transition between an open position and a closed position. In the closed position, the drawer assembly 12 is in a retracted state such that it is concealed within the housing 14. As such, when in the closed position, the drawer assembly 12 does not collect dirt and/or debris and is not susceptible to being bumped into and broken by individuals or objects.

As set forth above and illustrated more clearly in FIG. 2, the drawer assembly 12 is capable of being placed in an open position. In the open position, the drawer assembly 12 is capable of removably receiving a portable digital audio player 16 so that audio files stored in the DAP 16 may be played or audibly reproduced by the digital audio speaker system 10. The digital audio player 16 is thus capable of being “docked” in the drawer assembly 12 when the drawer assembly 12 is placed in the open position. When an individual removes the DAP 16, the drawer assembly 12 may be return to the closed position either automatically or by an individual.

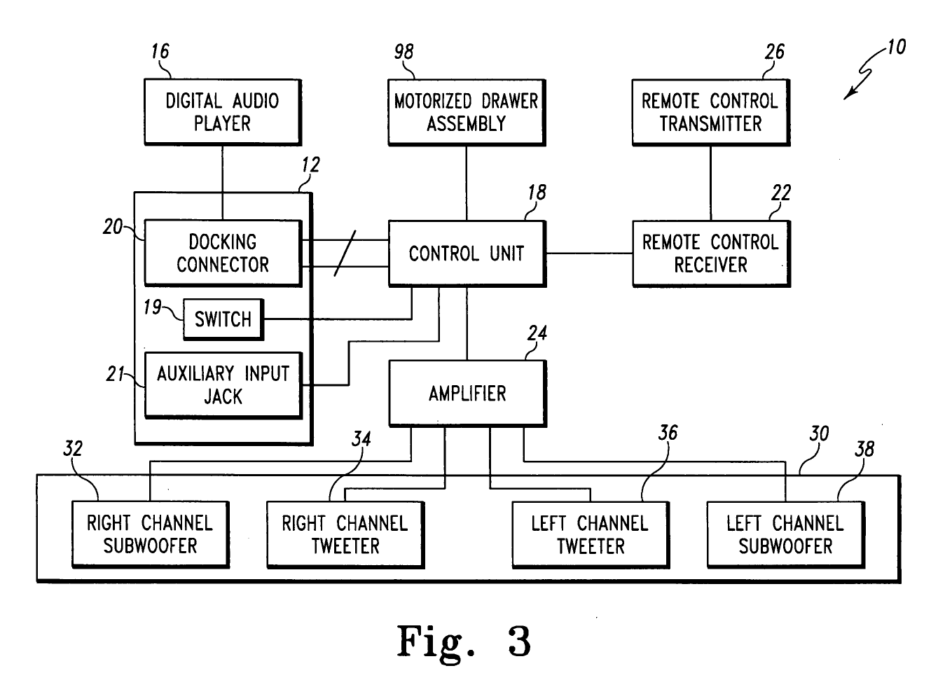

Referring to FIG. 3, a block diagram of the digital audio speaker system 10 is illustrated. The digital audio speaker system 10 includes a control unit 18 that controls the overall operation of the digital audio speaker system 10. The control unit 18 may be selected from any number of microprocessor based control units commonly found in the art. The control unit 18 is connected with the drawer assembly 12, which includes a sensor switch 19, the docking connector 20 and an auxiliary input jack 21. The sensor switch 19 allows a user to open and close the drawer assembly 12 with the press of a button or by positioning a finger close to the sensor switch 19. The control unit 18 is also connected with a remote control receiver 22, an amplifier 24, and a motor 98. As set forth in greater detail below, the drawer assembly 12 and the motor 98 are connected with the control unit 18 so that the control unit 18 can control the opening and closing of the drawer assembly 12.

The docking connector 20 is connected with the control unit 18 so that the DAP 16 and the control unit 18 can communicate with one another when the DAP 16 is docked or connected with the docking connector 20. As such, the docking connector 20 provides an electrical interface between the control unit 18 and the DAP 16. The specific size, shape, and number of connection pins of the docking connector 20 may vary depending on the particular type of DAP 16 that is desired to be docked with the digital audio speaker system 10. In addition, although not illustrated, various adapters may be sold with the digital audio speaker system 10 that allow various different types of DAPs 16 to be connected with the docking connector 20. The auxiliary input jack 21 of the drawer assembly 12 allows the DAP 16 to be connected with the control unit 18 via a cord or other type of adapter thereby eliminating the need to “dock” the DAP 16. The auxiliary input jack 21 may be located in the drawer assembly 12 or on a portion of the housing 14 such as, for example, on a side portion, front portion, top portion, bottom portion or rear portion of the housing 14.

The remote control receiver 22 is connected with the control unit 18 so that a remote control transmitter 26 may be used to control the DAP 16 while it is docked in the drawer assembly 12. The remote control receiver 22 is capable of receiving commands from the remote control transmitter 26 and forwarding those commands to the control unit 18 for processing. The remote control transmitter 26 maps functions of the digital audio player 16so that control buttons on the remote control transmitter 26 correspond to control buttons on the DAP 16. The docking connector 20 allows for two-way communication to be conducted between the DAP 16 and the control unit 18. As such, the remote control transmitter 26 may be used to control the DAP 16 while it is docked without the necessity of pressing buttons or using controls located on the DAP 16.

The amplifier 24 receives audio signals from the control unit 18, which receives the audio signals from the DAP 16 and converts them to audio signals useable by the amplifier 24. The amplifier 24 amplifies the audio signals before they are forwarded to a speaker system 30 positioned in the housing 14. Those skilled in the art would recognize that various types of amplifiers 24 may be utilized in the present invention. The speaker system 30 illustrated in FIG. 3 includes a right channel subwoofer 32, a right channel tweeter 34, and left channel tweeter 36, and a left channel subwoofer 38. Those skilled in the art would recognize that the speaker system 30 can include any number or type of speakers including woofers, tweeters, piezoelectric, electrostatic, horn-type, or planar magnetic speakers to name a few.

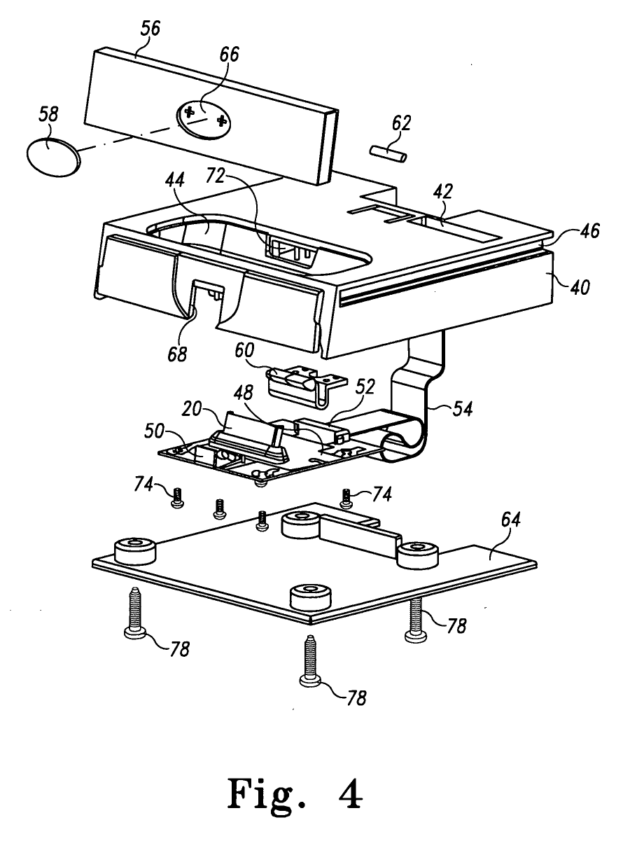

Referring to FIG. 4, the drawer assembly 12 includes a drawer 40 that includes a slot 42, a recessed tray 44, and a pair of track recesses 46. Although not illustrated, the second track recess 46 is located on the opposing side of the drawer 40. In addition, the drawer assembly 12 includes a printed circuit board 48, which contains the docking connector 20, a capacitive charge-transfer or proximity sensing electrode 50, and a connector 52. The docking connector 20 and the proximity sensing electrode 50 are connected with the connector 52. A flexible ribbon cable 54 is used to connect the docking connector 20 and the proximity sensing electrode 50 to the control unit 18. The proximity sensing electrode 50 may replace sensor switch 19 illustrated in FIG. 3, which may comprise a more conventional switch. The unique quality of proximity sensing electrode 50 is that when a user places their hand near the front of the drawer assembly 12, the proximity sensing electrode 50 senses this fact and may either open or close the drawer assembly 12 without the user actually physically touching anything.

The drawer assembly 12 also includes a front trim panel 56, a logo 58, a latch 60, an isolation pad 62, and a bottom cover 64. The front trim panel 56 is connected with a front portion of the drawer 40. The logo 58 is connected with a recess 66 located in the front trim panel 56. When assembled, the proximity sensing electrode 50 fits within an opening 68 located in the drawer 40 such that when a user places their finger over or in proximity of the logo 58, the proximity sensing electrode 50 is capable of sensing it and generates a signal that is sent to the control unit 18. This allows the control unit 18 to know whether to open or close the drawer assembly 12. The control unit 18 can also sense, by way of the docking connector 20, when the DAP 16 is removed from the docking connector 20 and may automatically close the drawer assembly 12 when the DAP 16 is removed or undocked.

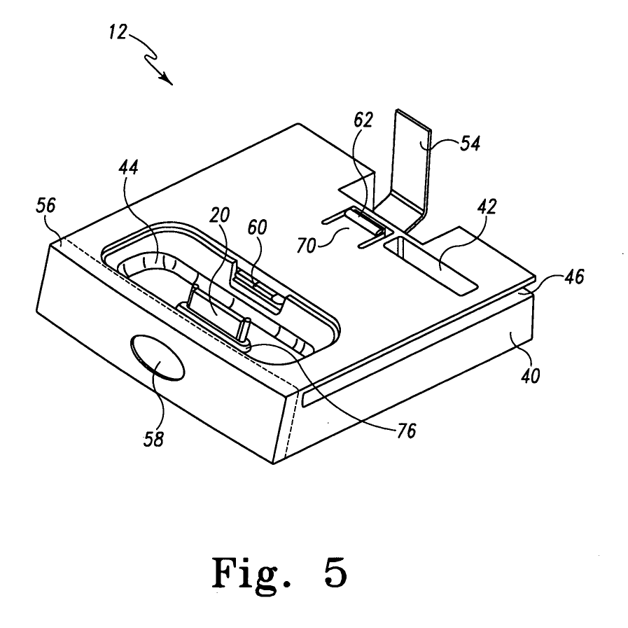

Referring collectively to FIGS. 4 and 5, the manner in which the drawer assembly 12 is assembled will be described. The isolation pad 62 is connected with a tab 70 at a rear portion of the drawer 40. The latch 60 is connected with an inner upper surface of the drawer 40 such that a portion of the latch 60 protrudes through an aperture 72 in the recessed tray 44. The latch 60 is used to retain inserts in the recessed tray 44. Each insert is designed to fit a specific type of DAP 16 so that different kinds of DAPs 16 may be utilized in the digital audio speaker system 10. The latch 60 may be connected with the drawer 40 using screws, glue, in a friction fit arrangement, or by any other conventional connection device. The printed circuit board 48 is connected with an inner upper surface of the drawer 40 with a plurality of screws 74. As illustrated in FIG. 5, the printed circuit board 48 is attached to the drawer 40 such that the docking connector 20 extends through an aperture 76 in the bottom of the recessed tray 44. Referring back to FIGS. 4 and 5, once the printed circuit board 48 is connected, the bottom cover 64 may be connected with the drawer 40 using a plurality of screws 78. Although screws 74, 78 are used in this embodiment of the present invention, it should be appreciated that other types of connection devices may be utilized as well.

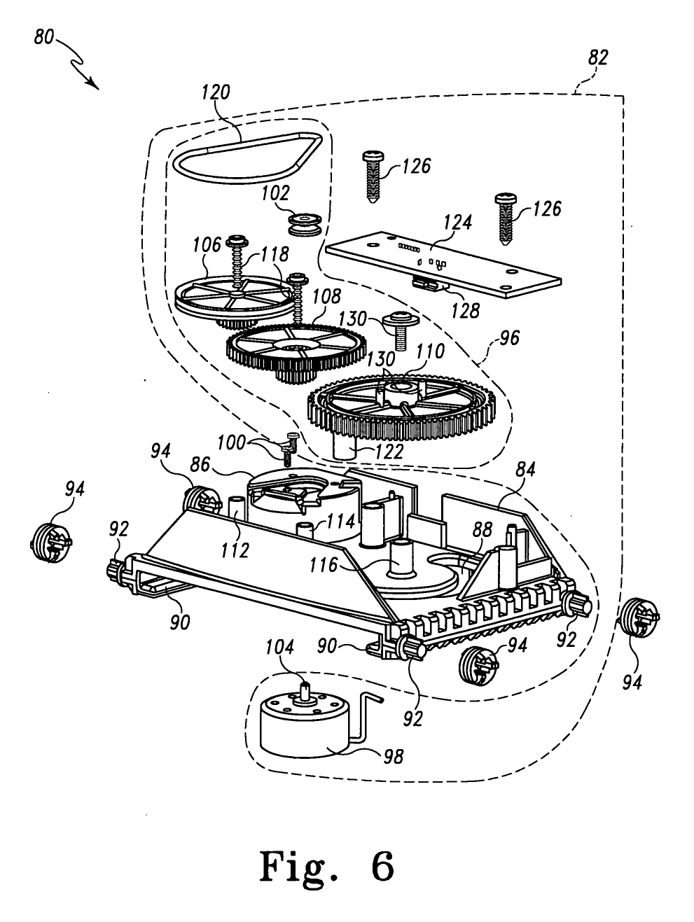

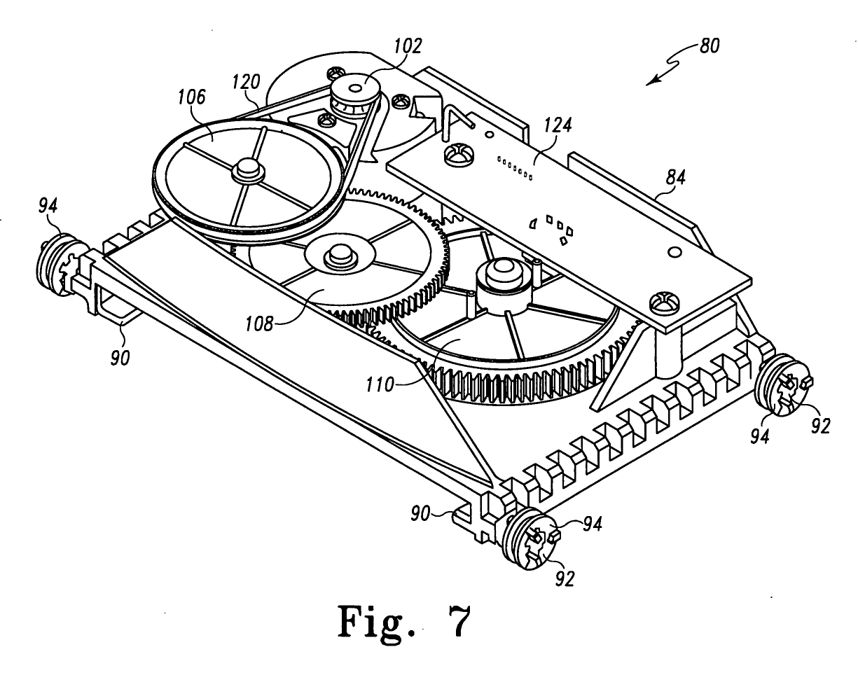

Referring to FIGS. 6 and 7, a frame assembly 80 is illustrated that is positioned within the housing 14 when the digital audio speaker system 10 is assembled. In alternative embodiments, the frame assembly 80 may be manufactured or molded as an integral part of the housing 14 and not as a separate assembly as illustrated. The frame assembly 80 is used to secure a motorized drive assembly 82 within the housing 14. The motorized drive assembly 82 is operational to move the drawer assembly 12 between the open and closed positions. As set forth in greater detail below, the drawer assembly 12 movably fits within or is positioned in the frame assembly 80. The frame assembly 80 is used to movably support the drawer assembly 12 within the housing 14. During operation, the drawer assembly 12 slides in and out of the housing 14 on the frame assembly 80. The motorized drive assembly 82 is operable to move the drawer assembly 12 in and out of the housing 14.

The frame assembly 80 includes a frame 84 that is used to secure the motorized drive assembly 82 in place. The frame 84 includes a motor housing 86, a circular clearance slot 88, a pair of opposing tracks 90, two pair of opposing mounting extensions 92, and grommets 94 connected with the two pair of opposing mounting extensions 92. The motorized drive assembly 82 includes a gear assembly 96 that moves the drawer assembly 12 between the open and closed positions.

A motor 98, of the motorized drive assembly 82, is positioned in the motor housing 86 of the frame 84. A pair of screws 100 holds the motor 98 in the motor housing 86. As illustrated in FIG. 3, the motor 98 of the drawer assembly 12 is connected with the control unit 18. The motor 98 provides rotational force to the gear assembly 96 under the control of the control unit 18. When a user touches or comes into close proximity with the proximity sensing electrode 50, the control unit 18 is operational to engage the motor 98 to either open or close the drawer assembly 12.

Referring back to FIGS. 6 and 7, a pulley 102 of the gear assembly 96 is connected with a drive shaft 104 of the motor 98. The gear assembly 96 includes a pulley-gear 106, a compound gear 108, and a drive gear 110. The pulley-gear 106 is rotatably connected with the frame 84 on a standoff 112 located on the frame 84. The compound gear 108 and the drive gear 110 are also rotatably connected with respective standoffs 114, 116 of the frame 84. Screws 118 are used to connect the pulley-gear 106, the compound gear 108 and the drive gear 110 to the respective standoffs 112, 114, 116.

A belt 120 is connected with the pulley 102 and the pulley-gear 106. The belt 120 provides rotational force to the pulley-gear 106 from the motor 98. The pulley-gear 106 is connected with the compound gear 108 and the compound gear 108 is connected with the drive gear 110. As such, rotation of the motor 98 causes the pulley-gear 106, the compound gear 108, and the drive gear 110 to rotate. The motor 98 is capable of rotating in both directions and as such, the belt 120 is capable of turning the pulley-gear 106, and therefore the compound gear 108 and the driver gear 110 by means of the pulley-gear 106, in both directions as well.

The drive gear 110 includes a pin 122 that protrudes downwardly from a lower surface of the drive gear 110. When assembled, the pin 122 is inserted through the circular clearance slot 88 of the frame 84 and into the slot 42 of the drawer assembly 12. As the drive gear 110 rotates, the pin 122 slides inside the circular clearance slot 88 and the slot 42 to thereby cause the drawer assembly 12 to slide between the open and closed position. The mechanism created by the drive gear 110, the pin 122, the circular clearance slot 88 and the slot 42 is a Scotch Yoke mechanism.

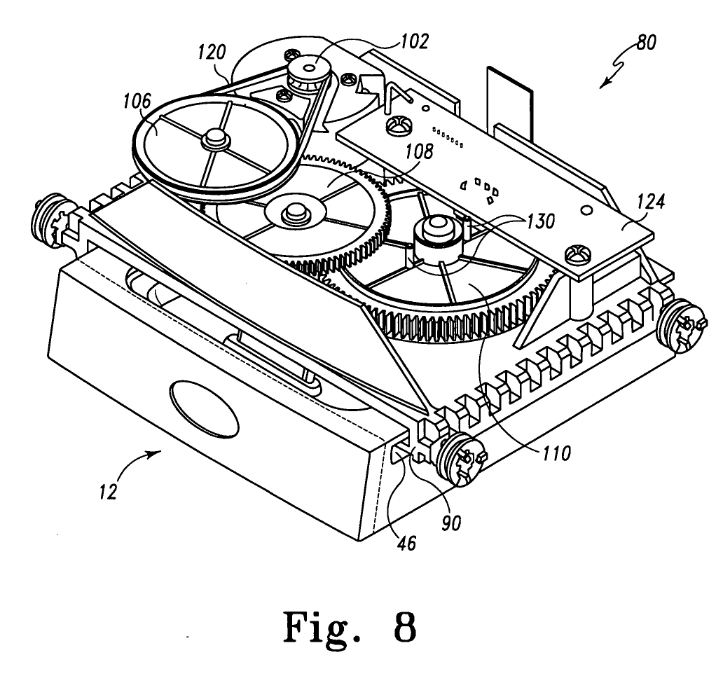

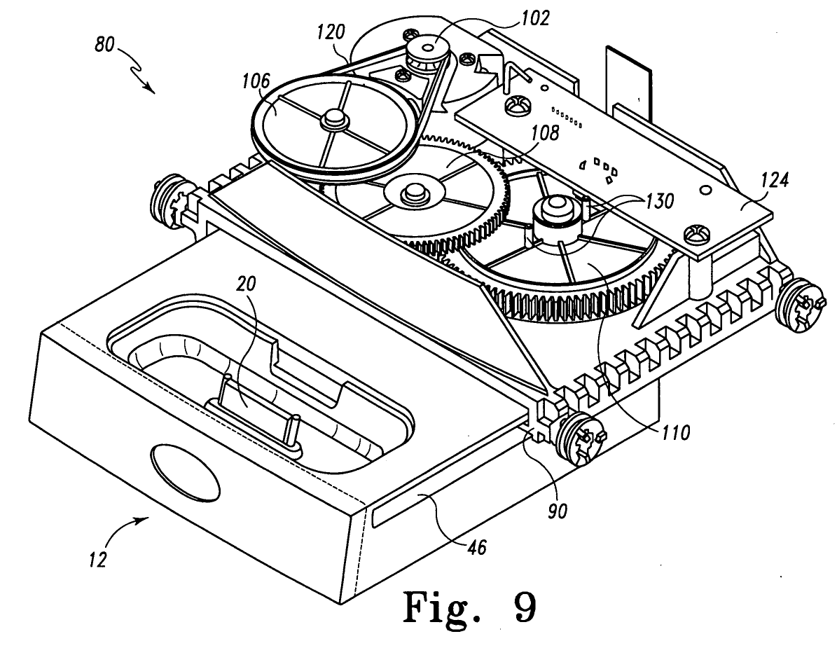

Referring to FIGS. 8 and 9, when the control unit 18 receives a signal from the proximity sensing electrode 50 that a user desires for the drawer assembly 12 to open, the control unit 18 engages the motor 98 to thereby turn the gear assembly 96. As the drive gear 110 of the gear assembly 96 rotates, the pin 122 causes the drawer assembly 12 to slide on the track recesses 46 to the open position thereby exposing the docking connector 20. As illustrated, the track recesses 46 of the drawer assembly 12 fit within the tracks 90 of the frame assembly 80, thereby allowing the drawer assembly 12 to slide back and forth on the tracks 90. The slot 42 in the drawer 40 allows the pin 122 to travel a predetermined distance, which provides a self-locking feature to lock the drawer assembly 12 in either the fully open or fully closed position.

The slot 42 in the drawer 40 and the pin 122 of the drive gear 110 create a Scotch Yoke mechanism that is operable to lock the drawer assembly 12 in either the fully open or fully closed position. The slot 42 limits the amount of distance the pin 122 is able to travel and when the pin 122 reaches either end of the slot 42 it self-locks in place. As such, the drawer assembly 40 includes a self-locking feature that is capable of locking the drawer assembly 12 in either the open or close position. When the drawer assembly 12 is closed, the motor 18 rotates the gear assembly 96 in the opposite direction than when opening the drawing assembly 12. In alternative embodiments, the belt 120, pulley-gear 106, and Scotch Yoke mechanism (as set forth above) could be eliminated and replaced with a worm gear attached to the shaft 104 of the motor 98. The worm gear drive could also be self-locking depending upon the gear geometry.

Referring to FIGS. 3 and 6, a switch printed circuit board 124 may be connected with the frame assembly 80 by screws 126. The switch printed circuit board 124 may include a limit switch 128. The limit switch 128 may comprise a three-way three terminal switch that is capable detecting three positions, which correlate to open, traveling or closed. The limit switch 128 is connected with the control unit 18 so that the control unit 18 can detect the relative position of the drawer assembly 12. The control unit 18 is capable of detecting whether the drawer assembly 12 is in an open position, a closed position, or traveling between the two. A pair of posts 130 that protrude upwardly from an upper surface of the drive gear 110 make contact with the limit switch 128 thereby placing the limit switch 126 in one of the respective switch settings during operation.

Referring to FIGS. 1, 2, 8 and 9, the frame assembly 80 is positioned or rests within the housing 14 using the grommets 94. The grommets 94 help to relax manufacturing tolerances for the housing 14 and the frame 84. The grommets 94 also simplify installation of the frame assembly 80 because no tools are required to install the frame assembly 80 into the housing 14 and the installation force is also low. Further, the grommets 94 help reduce motor noise transmissions when the drawer assembly 12 is operating. As illustrated in FIG. 4, the isolation pad 62 contacts the frame assembly 80 when the drawer 40 is in the open position to decrease movement of the drawer assembly 12 when installing or removing the DAP 16 to the docking connector 20. As such, the drawer assembly 12 relaxes manufacture tolerances, simplifies assembly, and enhances the stability of the drawer assembly 12 when installing or removing the DAP 16.

Another aspect of the present invention discloses a method of docking a digital audio player 16 in a digital audio speaker system 10. The method comprises the steps of maintaining a drawer assembly 12 in a concealed retracted position on a frame assembly 80 inside a housing 14; moving the drawer assembly 12 to an open position that exposes a docking connector 20 with a motorized drive assembly 82; and docking the digital audio player 16 on the docking connector 20 once the drawer assembly 12 reaches the open position.

Yet another aspect of the present invention discloses a digital audio speaker system 10 for a digital audio player 16. The digital audio speaker system 10 includes a housing 14 and a frame assembly 80 fixedly positioned in the housing 14. A drawer assembly 12 is positioned in the frame assembly 80 such that the drawer assembly 12 is capable of being moved between an open position that exposes a docking connector 20 and a closed position that conceals the docking connector 20. The digital audio speaker system 10 further includes means for moving the drawer assembly 12 between the open and closed positions.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A digital audio speaker system for a digital audio player, comprising:
a housing;
a control unit positioned in said housing;
an amplifier positioned in said housing and connected with said control unit and a speaker system;
a frame assembly having a motorized drive assembly; and
a drawer assembly movably connected with said motorized drive assembly, wherein said motorized drive assembly is operable to move said drawer assembly between an open position and a closed position.

2. The digital audio speaker system of claim 1, wherein said drawer assembly includes a docking connector.

3. The digital audio speaker system of claim 2, wherein said docking connector is exposed from said housing when said drawer assembly is in said open position.

4. The digital audio speaker system of claim 3, wherein said digital audio player may be connected with said docking connector when said drawer assembly is in said open position.

5. The digital audio speaker system of claim 1, wherein said drawer assembly includes a recessed docking tray.

6. The digital audio speaker system of claim 1, wherein a docking connector is connected with a printed circuit board that is connected with said drawer assembly such that said docking connector protrudes upwardly through an aperture in a lower surface of a recessed docking tray.

7. The digital audio speaker system of claim 6, wherein said docking connector is connected by said printed circuit board with a cable connector, wherein a flexible ribbon cable is used to connect said cable connector with said control unit thereby creating an interface between said docking connector and said control unit.

8. The digital audio speaker system of claim 1, wherein said frame assembly includes a first and second track, wherein said drawer assembly includes a first and second track recess, wherein said first and second track recesses slidably fit in said first and second tracks thereby allowing said drawer assembly to travel back and forth between said open and closed positions on said first and second tracks.

9. The digital audio speaker system of claim 1, wherein said frame assembly includes a motor mounting portion, wherein said motorized drive assembly includes a motor positioned in said motor mounting portion.

10. The digital audio speaker system of claim 9, wherein a pulley is connected with a shaft of said motor, wherein said pulley is connected by a belt to a gear assembly operable to move said drawer assembly between said open and closed positions under control of said motor.

11. The digital audio speaker system of claim 10, wherein said gear assembly includes a pulley-gear, a compound gear and a drive gear.

12. The digital audio speaker system of claim 11, wherein said belt is connected with said pulley and said pulley-gear, wherein said pulley-gear is connected with said compound gear, and said compound gear is connected with said drive gear.

13. The digital audio speaker system of claim 1, wherein said motorized drive assembly includes a motor and a gear assembly, wherein said motor is operable to selectively turn said gear assembly to move said drawer assembly between said open and closed positions.

14. The digital audio speaker system of claim 1, wherein said drawer assembly includes a slot and said frame assembly includes a circular clearance slot, wherein said motorized drive assembly includes a gear assembly having a drive gear that includes a pin that protrudes downwardly through said circular clearance slot and into said slot of said drawer assembly.

15. The digital audio speaker system of claim 14, wherein said motorized drive assembly includes a motor connected with said gear assembly, wherein as said motor rotates said gear assembly in a first direction said pin travels along said circular clearance slot and in said slot thereby moving said drawer assembly to said open position and as said motor rotates said gear assembly in a second direction said pin travels along said circular clearance slot and in said slot thereby moving said drawer assembly to said closed position.

16. The digital audio speaker system of claim 1, further comprising an auxiliary input jack.

17. The digital audio speaker system of claim 1, wherein said motorized drive assembly is operable to lock said drawer assembly in said open position and said closed position.

18. A digital audio speaker system for a digital audio player, comprising:
a frame assembly having a motor connected with a gear assembly; and
a drawer assembly movably connected with said frame assembly having a docking connector for said digital audio player, wherein said drawer assembly is connected with said gear assembly, wherein said motor is operable to control said gear assembly such that said drawer assembly is capable of being placed in an open position that exposes said docking connector for receiving said digital audio player and a closed position that conceals said docking connector when said digital audio player is not connected with said docking connector.

19. The digital audio speaker system of claim of claim 18, wherein said gear assembly includes a pulley-gear, a compound gear, and a drive gear.

20. The digital audio speaker system of claim of claim 18, wherein said drawer assembly includes a slot and a gear of said gear assembly includes a pin that protrudes downwardly through said frame assembly and into said slot to form a scotch yoke mechanism operable to lock said drawer assembly in said open and closed positions.

21. The digital audio speaker system of claim 20, wherein movement of said gear causes said pin to traverse said circular clearance slot thereby allowing movement of said drawer assembly between said locked open and closed positions.

22. The digital audio speaker system of claim 18, further comprising a limit switch for detecting when said drawer assembly is in either said open position or said closed position.

23. The digital audio speaker system of claim 18, wherein said drawer assembly includes a pair of track recesses that slidably fit within a pair of tracks of said frame assembly, wherein said drawer assembly slides back and forth on said pair of tracks.

24. The digital audio speaker system of claim 18, wherein said docking connector is connected with a printed circuit board that is connected with a control unit.

25. The digital audio speaker system of claim 18, wherein said drawer assembly includes a recessed docking tray, wherein said docking connector protrudes upwardly through an aperture in said recessed docking tray.

26. The digital audio speaker system of claim 18, further comprising a proximity sensing electrode positioned in said drawer assembly, wherein said proximity sensing electrode is connected with a control unit, wherein said control unit opens and closes said drawer assembly in response to signals from said proximity sensing electrode.

27. A method of docking a digital audio player in a digital audio speaker system, comprising:
maintaining a drawer assembly in a concealed retracted position on a frame assembly inside a housing;
moving said drawer assembly to an open position that exposes a docking connector with a motorized drive assembly; and
docking said digital audio player on said docking connector once said drawer assembly reaches said open position.

28. The method of claim 27, wherein said drawer assembly includes a pair of track recesses positioned in a pair of tracks of said frame assembly, wherein said drawer assembly moves on said pair of tracks.

29. The method of claim 27, wherein said motorized drive assembly comprises a motor connected with a gear assembly.

30. The method of claim 29, wherein said gear assembly includes a pulley, a pulley-gear, a compound gear and a drive gear.

31. A digital audio speaker system for a digital audio player, comprising:
a frame having a motor housing, a circular clearance slot, a first track and a second track;
a motor positioned in said motor housing;
a pulley connected with a shaft of said motor;
a pulley-gear rotatably connected with said frame, wherein a belt is connected with said pulley and said pulley-gear to thereby allow rotational force to be provided from said motor to said pulley-gear;
a compound gear rotatably connected with said frame and said pulley-gear;
a drive gear rotatably connected with said frame and said compound gear, wherein said drive gear includes a downwardly protruding pin that is positioned within an inside diameter of said circular clearance slot;
a drawer assembly having a first track recess and a second track recess positioned in said first track and said second track such that said drawer assembly is capable of moving back and forth along said first and second tracks, wherein said drawer assembly includes a slot, wherein a portion of said pin protruding through said circular clearance slot fits within said slot, wherein said drawer assembly includes a docking port for allowing said digital audio player to be docked in said drawer assembly.

31. A digital audio speaker system for a digital audio player, comprising:
a housing;
a frame assembly positioned in said housing;
a drawer assembly movably positioned in said frame assembly such that said drawer assembly is capable of being moved between an open position that exposes a docking connector and a closed position that conceals said docking connector; and
means for moving said drawer assembly between said open and closed positions.

32. A digital audio speaker system for a digital audio player, comprising:
a housing having a frame assembly;
a drawer assembly movably positioned in said frame assembly such that said drawer assembly is capable of being moved between an open position that exposes a docking connector and a closed position that conceals said docking connector; and
means for moving said drawer assembly between said open and closed positions.

33. A digital audio speaker system for a digital audio player, comprising:
a housing having a frame assembly;
a drawer assembly movably positioned in said frame assembly such that said drawer assembly is capable of being moved between a locked open position that exposes a docking connector and a locked closed position that conceals said docking connector; and
means for moving said drawer assembly between said locked open and closed positions.
